(19) United States
(12) Patent Application Publication
(10) Pub. No.: US 2008/0022303 A1
(43) Pub. Date: Jan. 24, 2008

(54) METHOD AND APPARATUS FOR SUPPLEMENTING CHANNEL INFORMATION

(75) Inventors: Chien-Ying Lu, Taipei Hsien (TW); Yu-Hsiung Deng, Hsin-Chu Hsien (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: MEDIATEK INC., Hsin-Chu (TW)

(21) Appl. No.: 11/778,188

(22) Filed: Jul. 16, 2007

Related U.S. Application Data
(60) Provisional application No. 60/807,957, filed on Jul. 21, 2006.

(51) Int. Cl. G06F 13/00

(52) U.S. Cl. 725/38

(57) ABSTRACT

A channel list indicates a channel subset of a sequence of candidate channel locations. The channel list is stored in an electronic apparatus that receives and processes multimedia programs carries by channels in the channel subset. Instead of scanning every candidate channel location, the electronic apparatus partially scans the sequence of the channel locations by skipping channel locations of the channel subset. In addition, full channel scanning as well as validity check for the channel subset is applicable for updating the channel list.

### CROSS REFERENCE TO RELATED APPLICATIONS

This application claims the benefit of U.S. Provisional Application No. 60/807,957, filed on Jul. 21, 2006, which is incorporated herein by reference.

### BACKGROUND OF THE INVENTION

1. Field of the Invention

The invention relates to a method and apparatus for channel scan, and more particularly relates to a method and apparatus for efficiently supplementing add-on channels.

2. Description of the Related Art

FIG. 1 illustrates a flowchart of a conventional full-channel scan method. During initialization, a channel list is reset, e.g. being removed from a memory of a TV (step S11). Every candidate channel location is calculated (step S12). There is usually a constant distance or offset among channel locations. After identifying the first channel, it is easy to calculate a next location to determine whether at that the next location a valid channel exists. If the next location contains no valid channel, a certain distance or offset is further added to calculate the further next location. For each location, it is determined whether the calculated channel can be locked (step S13). The step identifies whether the currently calculated channel has valid contents. If the calculated channel cannot be locked, the process proceeds to step S12 to retrieve the next channel location for scanning.

If the channel can be locked, TV signals corresponding to the channel are extracted (step S14) and parsed (step S15), and channel information of the channel is stored in a channel list in the memory (step S16). Next, it is determined whether the channel scan is complete (step S17), and, if so, all the channels are displayed (step S18), and, if not, the process proceeds to step S11 to implement another full-channel scan.

When a television receiver is moved around, it needs to re-scan channels so as to provide a user a valid channel list. Sometimes, even a television receiver is not moved, available channels change. For example, some channels may only provide valid contents at certain time, e.g. only in the morning or at night. Sometimes, special circumstances of a transmission path between a television receiver and a television broadcaster may change and affect valid channels at the television receiver. In an experiment, it is found that a television receiver cannot receive certain channels during rush hour because the transmission path is cross a high way. Therefore, it is necessary for a television receiver to keep its channel list updated so that a user can watch all available channels.

Thus, the invention provides an add-on channel scan method for scanning only lost channels used in a digital television receiver.

### BRIEF SUMMARY OF THE INVENTION

A first embodiment according to the invention is a method for supplementing a channel list stored in an electronic apparatus. The electronic apparatus receives and processes multimedia programs carried by channels in a channel subset of a sequence of candidate channel locations. The channel subset is indicated by the channel list. The method includes at least following steps.

First, partially scan the sequence of the candidate locations by skipping the channel subset. Secondly, determine whether there is at least one previously unfound candidate channel location carrying program content during the step of partially scanning. Then, update the channel list by adding the previously unfound candidate channel location to the channel list. The above mentioned steps are repeated until all desired candidate channel locations, except those already in the channel list, are scanned to provide a most updated channel list. The multimedia programs may be television, radio or other multimedia contents.

A second preferred embodiment according to the invention is an electronic apparatus for receiving and processing multimedia programs. The multimedia programs are carried by channels in a channel subset of a sequence of candidate channel locations. The channel subset is indicated by a channel list. The electronic apparatus includes a tuner, a memory and a processor. The tuner is used for receiving information for an assigned channel location. The memory is used for storing the channel list. The processor controls the tuner to partially scan the sequence of the candidate locations by skipping the channel subset; determines whether there is at least one previously unfound candidate channel location carrying program content during the step of partially scanning; and updates the channel list by adding the previously unfound candidate channel location to the channel list.

With the invention, it is more efficiently to keep current channel list updated. Particularly, when the channels are not changed frequently, only few channel locations need to be re-scanned.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a conventional full-channel scan method;

FIG. 2A illustrates full channel scanning;

FIG. 2B illustrates the scan result after the full channel scanning;

FIG. 2C illustrates partially scanning;

FIG. 2D illustrates results after the partially scanning;

FIG. 3 is a flowchart illustrating the partially scanning method; and

FIG. 4 illustrates a hardware diagram of a television apparatus that supports partially scanning.

### DETAILED DESCRIPTION OF THE INVENTION

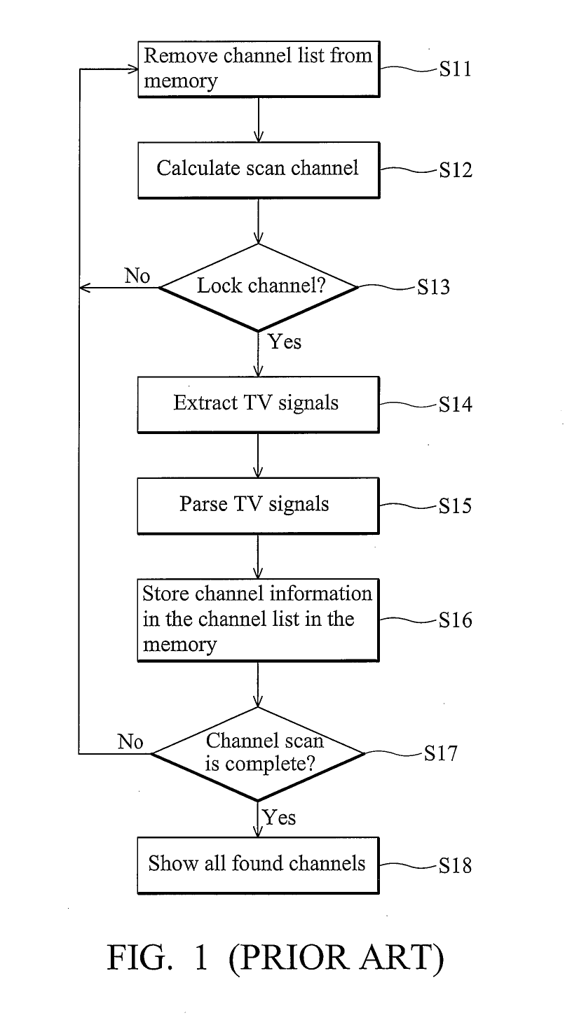

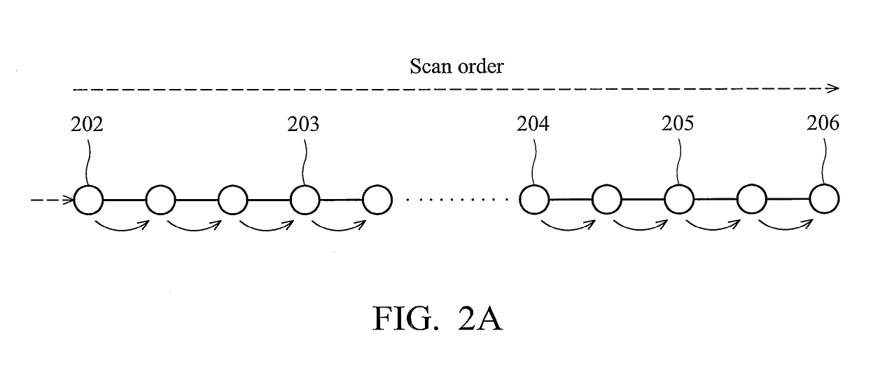

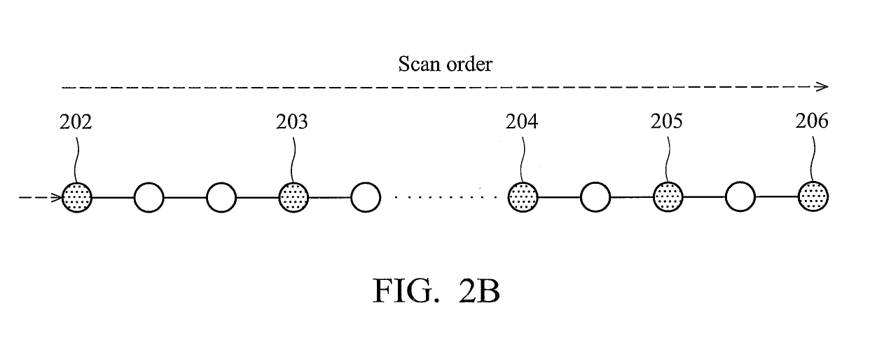

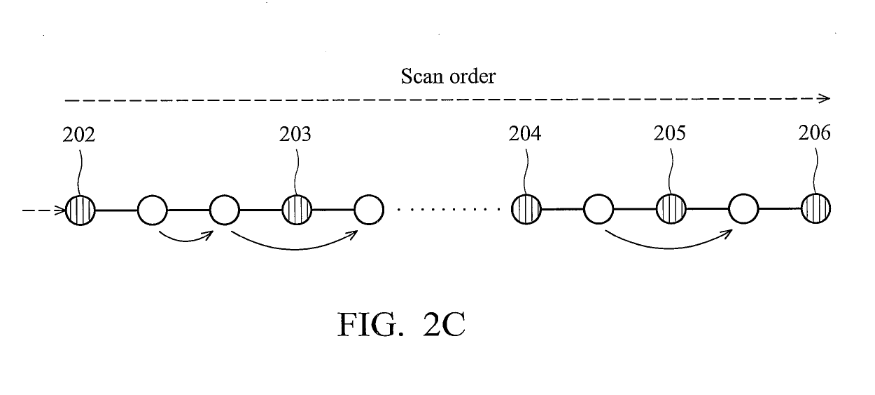

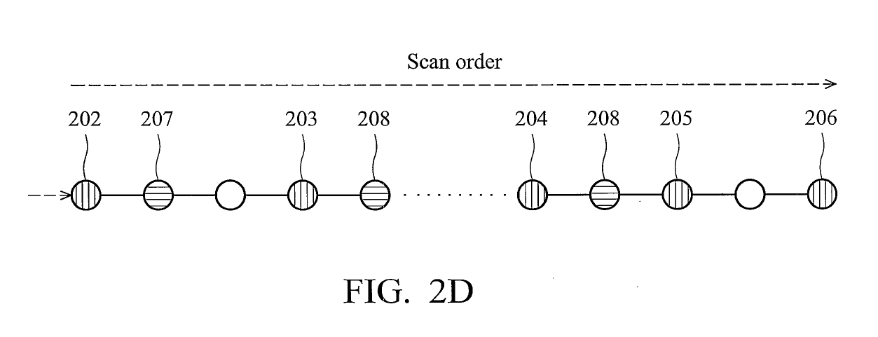

In the first preferred embodiment, a television receiver receives and processes television programs carried by channels in a channel subset of a sequence of candidate channel locations. FIG. 2A illustrates an example of one such sequence of candidate channel locations. The nodes between the node 202 and the node 204 represent frequency locations corresponding channels that may carry television programs. In real application, not every channel carries television programs at every moment. When the television receiver is powered on or activated by a user, the television receiver applies a full channel scan on the sequence of the candidate channel locations. FIG. 1 as well as descriptions as mentioned above explains how such full scanning is applied. FIG. 2B illustrates an example of scanning results. The nodes 202, 203, 204, 205 and 206 are found carrying valid program contents and the television receiver stores the channel list that can indicate the nodes 202, 203, 204, 205 and 206 carrying valid program contents.

Most television receivers are equipped with only one tuner and it usually takes a lot of time for performing a full scanning. If valid channels change, it is inefficiently to perform full scanning every time. But, without scanning, the channel list is not kept updated for showing all available channels to be selected by a user.

In the first preferred embodiment, therefore, the television receiver further performs a partially scanning in addition to the full scanning. In the partially scanning, the television processor skips scanning candidate locations that are already found valid according to the channel list. Only candidate channels that are not found carrying valid program contents are scanned. FIG. 2C illustrates such partially scanning by skipping the nodes 202, 203, 204, 205 and 206. After the partially scanning, the nodes 207 and 208, which are previously unfound candidate channel locations carrying program contents are then added to the channel list for updating the channel list as illustrated in FIG. 2D.

To make the television receiver operate more close to various needs, the television receiver may provide a configuration for setting when to perform the full scanning and when to perform the partially scanning. For example, the setting can be changed by users' input, e.g. via a remote controller. The setting and the channel list can be stored in various types of memories, e.g. DRAM, SDRAM, DDR RAM, flash memory, EEPROM, hard disk, depending on different design requirements. Also, the setting and the channel list can also be designed with various data structures. For example, the channel list may be implemented via a link list, an array or an index table. If two adjacent channels are spaced with a substantially constant distance, a calculation by adding the constant distance to a currently scanning location is made to find a next scanning location. In addition to television receiver design, a second preferred embodiment is to apply the partially scanning to a radio receiver for efficiently maintaining a channel list. For example, digital radio broadcasting also have a series of channels and not every channel carries valid program at every moment.

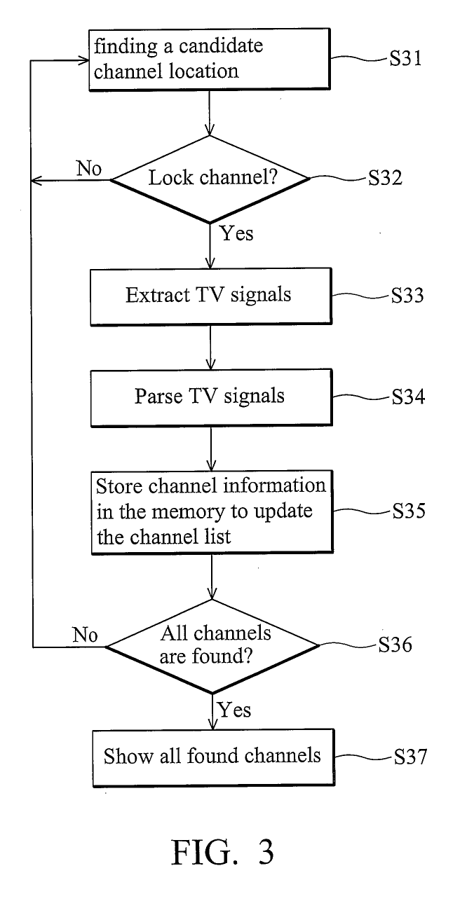

FIG. 3 is a flowchart illustrating a method for implementing partially scanning.

At first, an initial channel list is established and stored in a memory and the initial channel list may be an empty set. The initial channel list indicates known channel locations that carry valid program contents. Next, a channel location is selected to be scanned by skipping known candidate channel locations indicated by the channel list (step S31).

Next, it is determined whether the selected channel location can be locked (step S32), i.e. carrying valid program contents. If the channel location cannot be locked, the process proceeds to step S31 to select a next channel location not stored in the channel list for scanning. If the selected channel location can be locked, TV signals corresponding to the selected channel are extracted (step S33) and parsed (step S34), and channel information of the channel is stored in the memory to update the channel list (step S35). Next, it is determined whether all candidate channel locations are scanned (step S36), and, if so, the channels in the channel list are displayed (step S37), and, if not, the process proceeds to step S31 to select a next channel not stored in the channel list for scanning.

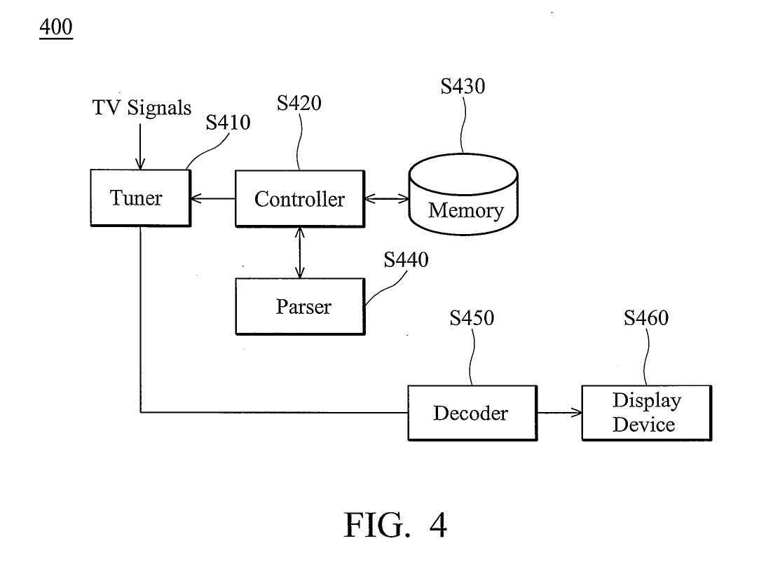

FIG. 4 illustrates a television (TV) apparatus 400, e.g. a television or a set top box (STB), supporting partially scanning.

The TV apparatus 400 includes a tuner 410, a controller 420 as a processor to the TV apparatus 400, a memory 430, a parser 440, a decoder 450, and a display device 460. In the case of a STB, the display device 460 is external. The controller 420 instructs the tuner 410 to receive TV signals form a TV system provider and maintains a candidate channel list that indicates available candidate channel locations. Next, the controller 420 instructs tuner 410 to receive TV signals form the TV system provider to implement a full-channel scan to generate a channel list. The candidate channel list and the channel list are stored in the memory 430.

Next, the controller 420 compares the candidate channel list with the channel list to determine whether a partially channel scanning is required, and, if so, calculates a channel to be scanned according to the comparison result based on user defined settings or other conditions, and determines whether the calculated channel can be locked. If the channel cannot be locked, the controller 420 further instructs the tuner 410 to receive TV signals from the TV system provider to calculate a next channel not stored in the channel list for scanning. If the channel can be locked, the controller 420 extracts TV signals corresponding to the channel, enables the parser 440 to parse the TV signals, and enables the decoder 450 to decode the parsed TV signals for display on the display device 460. Additionally, the controller 420 stores channel information of the channel in the memory 430 to update the channel list, and repeats the described process until all candidate channel are scanned.

Alternatively, the above method and apparatus can be applied to American or European digital TV, analog TV systems, Digital Video Broadcast-Handheld (DVB-H) TV systems, or radios.

The methods and apparatus of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for supplementing a channel list stored in an electronic apparatus, the electronic apparatus receiving and processing multimedia programs carried by channels in a channel subset of a sequence of candidate channel locations, the channel subset being indicated by the channel list, the method comprising:
partially scanning the sequence of the candidate locations by skipping the channel subset;
determining whether there is at least one previously unfound candidate channel location carrying program content during the step of partially scanning; and
updating the channel list by adding the previously unfound candidate channel location to the channel list.

2. The method of claim 1, wherein two adjacent candidate locations in the sequence of the candidate channel locations are spaced with a substantially constant distance.

3. The method of claim 2, wherein the candidate channel locations are frequency domain locations.

4. The method of claim 3, wherein the step of partially scanning comprises calculating next candidate location to scan by adding the constant distance to a currently scanned candidate location and checking whether the next candidate location is already on the channel list.

5. The method of claim 3, wherein the step of partially scanning comprises finding next candidate location by directly checking the channel list.

6. The method of claim 1, further comprising:
performing a full channel scan by scanning every candidate location of the sequence of the candidate locations to completely update the channel list.

7. The method of claim 6, further comprising:
configuring a setting to determine when to perform the full channel scan and when to perform the step of partially scanning.

8. The method of claim 1, further comprising:
performing a validity check on the channel subset to check whether each item of the channel subset carries valid program content.

9. The method of claim 1, wherein the multimedia programs are television programs.

10. The method of claim 1, wherein the multimedia programs are audio programs.(including digital radio programs)

11. An electronic apparatus for receiving and processing multimedia programs carried by channels in a channel subset of a sequence of candidate channel locations, the channel subset being indicated by a channel list, the electronic apparatus comprising:
a tuner for receiving information for an assigned channel location;
a memory for storing the channel list; and
a processor for controlling the tuner to partially scan the sequence of the candidate locations by skipping the channel subset; determining whether there is at least one previously unfound candidate channel location carrying program content during the step of partially scanning; and updating the channel list by adding the previously unfound candidate channel location to the channel list.

12. The electronic apparatus of claim 11, wherein two adjacent candidate locations in the sequence of the candidate channel locations are spaced with a substantially constant distance.

13. The electronic apparatus of claim 12, wherein the candidate channel locations are frequency domain locations.

14. The electronic apparatus of claim 13, wherein to partially scan, the processor calculates next candidate location to scan by adding the constant distance to a currently scanned candidate location and checks whether the next candidate location is already on the channel list.

15. The electronic apparatus of claim 13, wherein to partially scan, the processor finds next candidate location by directly checking the channel list.

16. The electronic apparatus of claim 11, wherein the processor further controls the tuner to perform a full channel scan by scanning every candidate location of the sequence of the candidate locations to completely update the channel list.

17. The electronic apparatus of claim 16, wherein the memory further stores a setting configured to determine when to perform the full channel scan and when to perform the step of partially scanning.

18. The electronic apparatus of claim 11, wherein the processor further performs a validity check on the channel subset to check whether each item of the channel subset carries valid program content.

19. The electronic apparatus of claim 11, wherein the multimedia programs are television programs.

20. The electronic apparatus of claim 11, wherein the multimedia programs are audio programs.
